(19) United States
(12) Patent Application Publication
(10) Pub. No.: US 2023/0271221 A1
(43) Pub. Date: Aug. 31, 2023

(54) VEHICLE COATING STRUCTURE

(71) Applicant: TOYOTA JIDOSHA KABUSHIKI KAISHA, Aichi-ken (JP)

(72) Inventors: Junya OGAWA, Okazaki-shi (JP); Nozomi TOYA, Toyota-shi (JP); Junya YAMAMOTO, Seto-shi (JP); Kenji YAMAGUCHI, Miyoshi-shi (JP)

(21) Appl. No.: 18/159,090

(22) Filed: Jan. 25, 2023

(30) Foreign Application Priority Data
Feb. 28, 2022 (JP) 2022-029153

(51) Int. Cl. B05D 7/00; B05D 7/14; B05D 1/02

(52) U.S. Cl. CPC B05D 7/574; B05D 7/14; B05D 1/02; B05D 2420/01; B05D 2501/00; B05D 2202/00

(57) ABSTRACT

Provided is a vehicle coating structure formed on a surface of a base plate of an exterior member of a vehicle. The vehicle coating structure includes: a coating layer formed on the surface of the base plate of the exterior member; a peelable layer formed on a surface of the coating layer or the surface of the base plate, the peelable layer having peelability; and a transparent matte layer formed on a surface of the peelable layer, the transparent matte layer being made of a transparent matte coating material.

### CROSS-REFERENCE TO RELATED APPLICATION

This application claims priority to Japanese Patent Application No. 2022-029153 filed on Feb. 28, 2022, incorporated herein by reference in its entirety.

### BACKGROUND

### 1. Technical Field

The present disclosure relates to a vehicle coating structure having a transparent matte layer made of a transparent matte coating material.

### 2. Description of Related Art

As for a vehicle coating structure, glossy coating having excellent glossiness is mainly used. However, in recent years, a matte coating that provides a dignified feeling has been preferably used in some cases. For example, Japanese Unexamined Patent Application Publication No. 2005-324363 (JP 2005-324363 A) describes a vehicle coating structure having a coating layer in which a coating film is formed by applying a matte coating material.

### SUMMARY

However, the coating layer (hereinafter referred to as a matte coating layer) in which the coating film is formed by applying the aforementioned matte coating material has a problem that, when irregularities on the surface of the coating layer disappear due to aged deterioration, matte texture deteriorates and turns into glossy texture.

In order to solve such a problem, the following vehicle coating structure is conceivable. That is, the vehicle coating structure is configured such that a peelable layer having peelability is formed on a coating layer (that may be a matte coating layer), and a matte coating layer is formed on the peelable layer. With the coating structure, in a case where the matte texture deteriorates, the matte coating layer and the peelable layer can be peeled off. However, the vehicle coating structure requires a high manufacturing cost and a high material cost.

In view of this, an object of the present disclosure is to provide a vehicle coating structure that can reduce a manufacturing cost and a material cost.

A vehicle coating structure according to the present disclosure is a vehicle coating structure formed on a surface of a base plate of an exterior member of a vehicle. The vehicle coating structure includes a coating layer, a peelable layer, and a transparent matte layer. The coating layer is formed on the surface of the base plate of the exterior member. The peelable layer is formed on a surface of the coating layer or the surface of the base plate, the peelable layer having peelability. The transparent matte layer is formed on a surface of the peelable layer, the transparent matte layer being made of a transparent matte coating material.

In the vehicle coating structure according to the present disclosure, the peelable layer and the transparent matte layer may be formed on the coating layer of each of some exterior members from among a plurality of exterior members provided as the exterior member of the vehicle.

In the vehicle coating structure according to the present disclosure, the peelable layer and the transparent matte layer may be formed only on the coating layer of the exterior member, the coating layer being visually observable.

With the vehicle coating structure of the present disclosure, it is possible to reduce a manufacturing cost and a material cost.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view illustrating a vehicle according to an embodiment;

FIG. 2 is a sectional view illustrating a vehicle coating structure as an example of the embodiment;

FIG. 3 is a sectional view illustrating a vehicle coating structure as another example of the embodiment;

FIG. 4 is another perspective view illustrating the vehicle according to the embodiment; and

FIG. 5 is a sectional view illustrating a vehicle coating structure in the related art.

### DETAILED DESCRIPTION OF EMBODIMENTS

Hereinafter, an exemplary embodiment of the present disclosure will be described in detail. In the following description, specific shapes, materials, directions, values, and the like are examples to facilitate understanding of the present disclosure and can be modified appropriately in conformity to a purpose, an object, a specification, and the like.

Vehicle

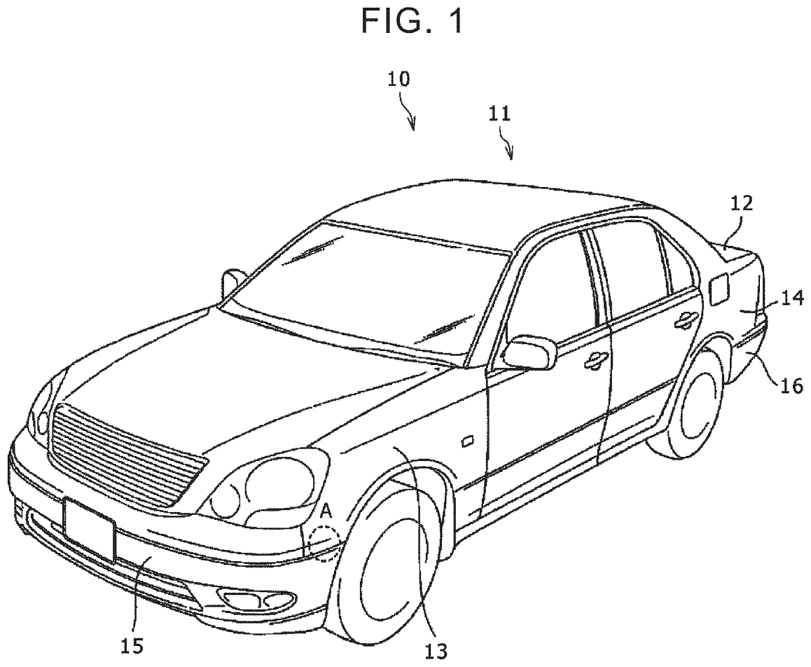

With reference to FIG. 1, the following describes a vehicle 10 according to the embodiment.

As illustrated in FIG. 1, the vehicle 10 is a four-wheeled passenger car, for example, but is not limited to this. The vehicle 10 includes exterior members 11. Here, the exterior members 11 include outer plates and exterior parts (described later).

The outer plates are members constituting a vehicle body and indicate outer plate panels that are visually observable (in other words, observable from outside the vehicle 10). The outer plates include, for example, a hood panel, a roof panel, a trunk lid 12, a front fender panel 13, a rear fender panel 14, a front door outer, a rear door outer, a front pillar, a center pillar, a rear pillar, and so on. As a material for the outer plates, a hot rolled steel plate or a cold rolled steel sheet is used, for example.

The exterior parts are outfitting components visually observable and configured be assembled to the vehicle body. The exterior parts include, for example, a front bumper cover 15, a rear bumper cover 16, a rocker panel molding, a door handle, a fuel filler cover, a side mirror, a roof molding, a door belt molding, a weather strip, a window molding, and a shark fin, and so on. As a material for the exterior parts, a resin material is used. Note that a steel sheet may be used for the fuel filler cover.

Coating Structure

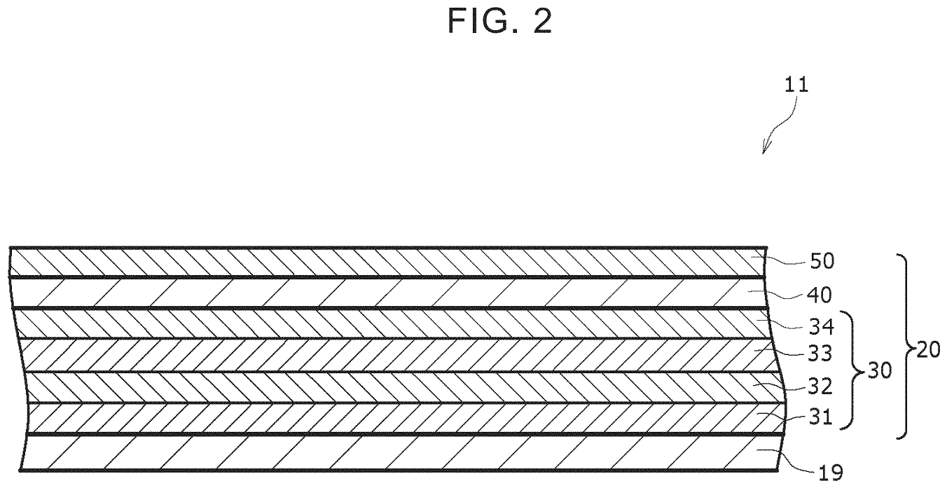

With reference to FIGS. 2 to 4, a coating structure 20 as an example of the embodiment will be described.

The outer plate as the exterior member 11 includes a base plate 19 made of a steel sheet or the like, and the coating structure 20 as a vehicle coating structure formed to cover the base plate 19. Further, the exterior part as the exterior member 11 includes a base plate 19 such as a resin member, and the coating structure 20 as a vehicle coating structure formed to cover the resin member. That is, in a case where the exterior member 11 is the outer plate, the base plate 19 indicates a steel sheet having a surface on which the coating structure 20 is formed, and in a case where the exterior member 11 is the exterior part, the base plate 19 indicates a resin member having a surface on which the coating structure 20 is formed. Note that the base plate 19 includes molded-in color coating resin that is a material obtained by coloring resin itself such that a coloring material such as a pigment is mixed with a resin material or a bright material and a coloring material are mixed with a resin material.

The coating structure 20 includes a coating layer 30 formed on the surface of the base plate 19, and a peelable layer 40 and a transparent matte layer 50 formed on a visually observable outer surface of the coating layer 30 or the base plate 19. Note that the peelable layer 40 and the transparent matte layer 50 may be formed on the whole surface of the coating layer 30. Note that, in a case where the base plate 19 is constituted by the aforementioned molded-in color coating resin, the peelable layer 40 and the transparent matte layer 50 may be formed on a visually observable outer surface of the base plate 19.

The coating layer 30 is a layer formed on the surface of the base plate 19 as described above, and it is preferable that the coating layer 30 be formed on each exterior member 11 before the vehicle 10 is completed. It is preferable the coating layer 30 be formed in a production factory for the vehicle 10.

The coating layer 30 includes an electrodeposited layer 31 formed to cover the whole surface of the base plate 19, an intermediate coating layer 32 formed on the whole surface of the electrodeposited layer 31, a base layer 33 formed on the whole surface of the intermediate coating layer 32, and a clear layer 34 formed on the whole surface of the base layer 33.

The electrodeposited layer 31 is a layer formed by an electrodeposition coating film hardened by baking by electrodeposition coating. The electrodeposition coating may be cationic electrodeposition coating, for example. A cationic electrodeposition coating material is not limited particularly, and a well-known material is used. The cationic electrodeposition coating material may include cationic base resin, a hardening agent, and a pigment.

The intermediate coating layer 32 is a layer formed of a colored intermediate coating film by applying a colored intermediate coating material containing a titanium dioxide pigment and a color pigment. The titanium dioxide pigment and the color pigment are not limited particularly, and well-known pigments are used.

The base layer 33 is a layer formed of a base coating material coating film by applying a base coating material. The base coating material is not limited particularly, and a well-known material is used. As the base coating material, a solvent-based colored base coating material or an aqueous colored base coating material is preferably used.

The clear layer 34 is a layer where a clear coating film is formed by applying a clear coating material. Film-forming resin and a hardening agent to be used for the clear coating material are not limited particularly, and well-known materials are used. The clear coating material may contain the film-forming resin and the hardening agent.

In the meantime, the coating layer 30 of the coating structure 20 of the exterior part includes a primer layer formed to cover the surface of the base plate 19, a base layer formed on the surface of the primer layer, and a clear layer formed on the surface of the base layer.

The peelable layer 40 is a resin coating film formed on the surface of the coating layer 30. Since the peelable layer 40 is formed by applying an easily peelable coating material, the peelable layer 40 has a peeling property in comparison with the coating layer and the transparent matte layer 50. A material for the easily peelable coating material is not limited in particular, provided that the material is easily peelable from the coating layer 30.

As the easily peelable coating material, a coating material formed by adding, to urethane-based resin or acrylic resin as a main material, for example, xylene, ethylbenzene, an oxidation inhibitor, methyl ethyl ketone, a silica reactant, titanium oxide (nanoparticles), an organic solvent, and so on is used preferably. The peelable layer 40 can be formed such that the coating material is applied by spray application, brush coating, or the like and then dried.

The peelable layer 40 and the transparent matte layer 50 (details thereof will be described later) may be formed on the coating structure 20 of each of some exterior members 11 from among the exterior members 11 of the vehicle 10. More specifically, the peelable layer 40 and the transparent matte layer 50 may be formed only in a part where a user desires dignified texture.

For example, the peelable layer 40 and the transparent matte layer 50 may be formed only on the surface of the coating layer 30 of each of the outer plates from among the exterior members 11. Further, the peelable layer 40 and the transparent matte layer 50 may be formed only on the surface of the coating layer 30 of each of the hood panel and the roof panel from among the outer plates. This makes it possible to achieve dignified texture in a part that the user desires.

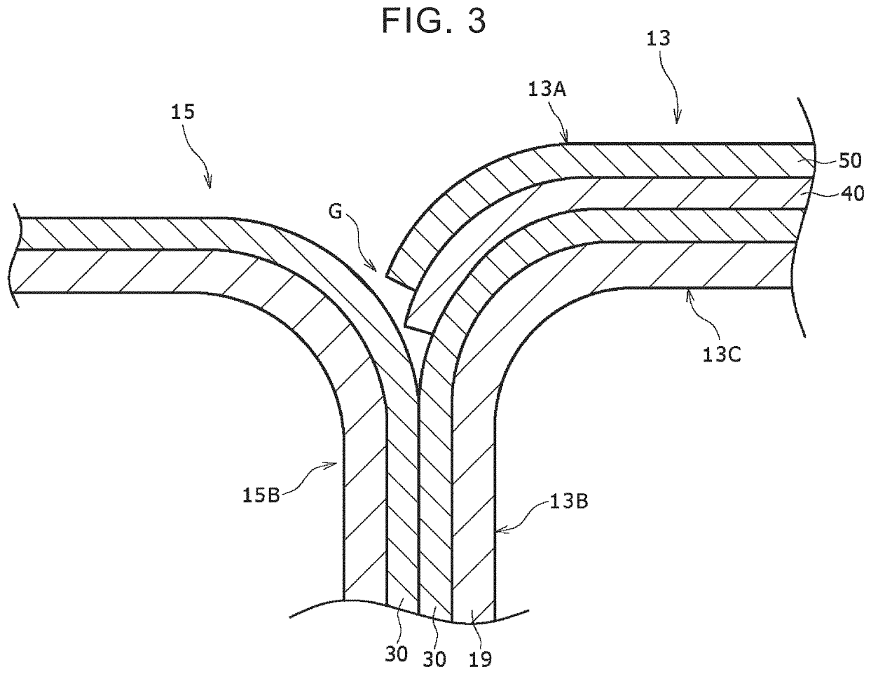

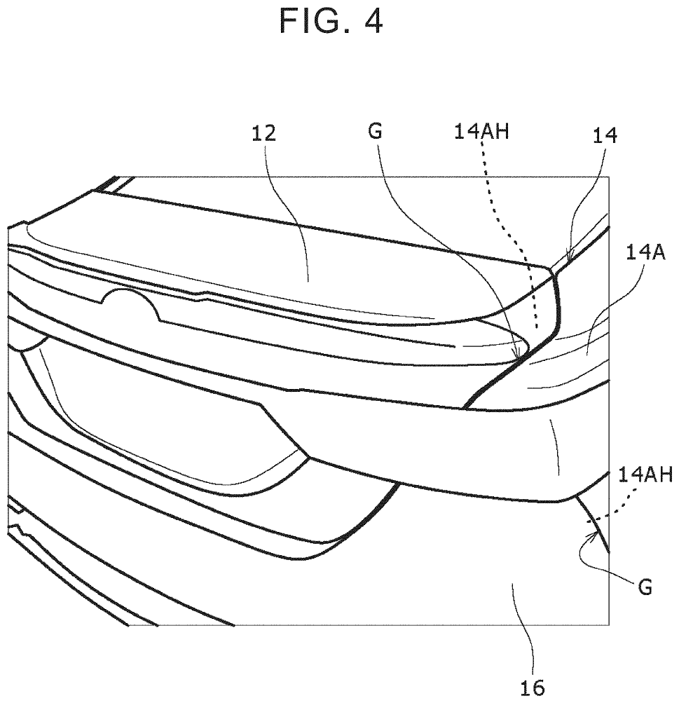

It is preferable that the peelable layer 40 and the transparent matte layer 50 be formed only on the visually observable surface of the coating layer 30 of the exterior member 11 as described above. Here, the visually observable surface indicates a part other than a part covered with another member provided thereon in an overlapping manner such as a side end surface 13B (see FIG. 3) of the front fender panel 13 (details will be described later), and a part 14AH (see FIG. 4) of the rear fender panel 14 that is covered with the trunk lid 12 and the rear bumper cover 16.

Hereby, the peelable layer 40 and the transparent matte layer 50 can be applied to each exterior member 11 after the vehicle 10 is completed. Further, the peelable layer 40 and the transparent matte layer 50 can be peeled off without disassembling the exterior members 11. Hereby, the peelable layer 40 and the transparent matte layer 50 can be applied or peeled off in a repair shop provided in a dealer for the vehicle 10. Note that the peelable layer 40 and the transparent matte layer 50 may be applied in a production factory for the vehicle 10.

The transparent matte layer 50 is a layer formed on the surface of the peelable layer 40 and formed from a transparent matte coating film by applying a transparent matte coating material. As a gloss value of a coating surface of the transparent matte layer 50, the 60-degree mirror reflectivity based on JIS K 5400 6-7 is equal to less than 50%, preferably equal to or less than 30%.

The transparent matte coating material is not limited particularly, and a well-known material is used. The matte performance of the transparent matte coating material may be achieved such that silica or resin beads are mixed in the transparent matte coating material to roughen the surface of a coating film. Further, as the transparent matte coating material, a coating material containing binder resin and urethane resin particles. The binder resin contains acrylate-modified chlorinated polypropylene, urethane resin, and a compatibilizer.

Since the transparent matte layer 50 is transparent, and the coating layer 30 is observable through the transparent matte layer 50, an edge (a boundary between the transparent matte layer 50 and the coating layer 30) of the transparent matte layer 50 is not outstanding in appearance. On that account, it is not necessary to perform masking finely at the time when the transparent matte coating material is applied. This makes it possible to reduce a manufacturing cost.

As described above, the peelable layer 40 and the transparent matte layer 50 are formed only on the visually observable surface of the coating layer 30. For example, as illustrated in FIG. 3, the visually observable surface of the front fender panel 13 is an outer surface 13A of the front fender panel 13 and does not include the side end surface 13B and a back surface 13C.

The side end surface 13B of the front fender panel 13 is the surface of a part bent toward the inside of the vehicle 10 from the outer surface 13A. The side end surface 13B faces a side end surface 15B of the front bumper cover 15 via a gap. The back surface 13C of the front fender panel 13 is a surface on the opposite side from the outer surface 13A.

In other words, outer peripheral edges G of the peelable layer 40 and the transparent matte layer 50 of the front fender panel 13 are formed along a joined portion between the front fender panel 13 and the front bumper cover 15. Hereby, it is possible to peel the peelable layer 40 and the transparent matte layer 50 of the front fender panel 13 without removing the front bumper cover 15 from the front fender panel 13.

Further, for example, as illustrated in FIG. 4, the visually observable surface of the rear fender panel 14 is a part of the outer surface 14A except the part 14AH covered with the trunk lid 12 and the rear bumper cover 16 provided to overlap with the part 14AH.

In other words, the outer peripheral edges G of the peelable layer 40 and the transparent matte layer 50 of the rear fender panel 14 are formed along an outer peripheral edge of the rear bumper cover 16 on the outer surface 14A of the rear fender panel 14. Hereby, the peelable layer 40 and the transparent matte layer 50 of the rear fender panel 14 can be peeled off in a state where the rear bumper cover 16 is closed relative to the rear fender panel 14.

### Effects

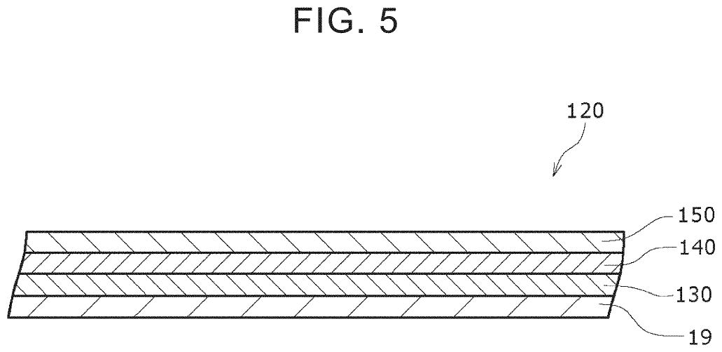

In the related art, in matte coating, when irregularities on the surface of a coating layer disappear due to aged deterioration, matte texture deteriorates and turns into glossy texture. In order to deal with this problem, a vehicle coating structure 120 illustrated in FIG. 5 has been used. The vehicle coating structure 120 is configured such that a peelable layer 140 having peelability is formed on a coating layer 130 (that may be a matte coating layer), and a matte coating layer 150 is formed on the peelable layer 140. However, the vehicle coating structure 120 requires a high manufacture cost and a high material cost.

With the coating structure 20 of the present embodiment, the transparent matte layer 50 is used instead of the matte coating layer 150, so that it is possible to omit a base layer (not illustrated) for the matte coating layer 150 and to reduce a material cost in comparison with the coating structure in the related art.

Further, with the coating structure 20, at the time when the peelable layer and the transparent matte layer 50 are applied to some of the exterior members 11 of the vehicle 10, it is not necessary to cover the coating layer 30 with the peelable layer 40 and the transparent matte layer 50. Accordingly, it is not necessary to perform masking finely, thereby making it possible to reduce a manufacturing cost.

Note that the present disclosure is not limited to the above embodiment and its modifications, and it is needless to say that various changes and alterations can be made within what is described in Claims of the present specification.

What is claimed is:

1. A vehicle coating structure formed on a surface of a base plate of an exterior member of a vehicle, the vehicle coating structure comprising:
a coating layer formed on the surface of the base plate of the exterior member;
a peelable layer formed on a surface of the coating layer or the surface of the base plate, the peelable layer having peelability; and
a transparent matte layer formed on a surface of the peelable layer, the transparent matte layer being made of a transparent matte coating material.

2. The vehicle coating structure according to claim 1, wherein the peelable layer and the transparent matte layer are formed on the coating layer of each of some exterior members from among a plurality of exterior members provided as the exterior member of the vehicle.

3. The vehicle coating structure according to claim 1, wherein the peelable layer and the transparent matte layer are formed only on the coating layer of the exterior member, the coating layer being visually observable.
